(19) United States
(12) Patent Application Publication
(10) Pub. No.: US 2016/0276113 A1
(43) Pub. Date: Sep. 22, 2016

(54) ELECTROCHEMICAL ENERGY STORAGE DEVICE AND METHODS OF FABRICATION

(71) Applicant: COOPER TECHNOLOGIES COMPANY, Houston, TX (US)

(72) Inventor: Chad David Johns, San Leandro, CA (US)

(21) Appl. No.: 14/663,511

(22) Filed: Mar. 20, 2015

(51) Int. Cl. H01G 11/78; H01G 11/52; H01G 11/86; H01G 11/30; H01G 11/58; H01G 11/38; H01G 11/26

(52) U.S. Cl. CPC H01G 11/78; H01G 11/38; H01G 11/52; H01G 11/26; H01G 11/30; H01G 11/58; H01G 11/86

(57) ABSTRACT

An embodiment of an electrochemical energy storage device has been disclosed. The device includes a housing, an electrolyte contained within the housing, and an electrode arrangement at least partially submerged in the electrolyte. The housing has an interior surface coated in an activated carbon material. Methods of fabrication are also described.

### BACKGROUND OF THE INVENTION

The field of the invention relates generally to the construction and fabrication of electrochemical energy storage devices and, more specifically, to the construction and fabrication of an electrochemical energy storage device such as a supercapacitor that is operable with improved performance in certain voltage ranges.

At least some conventional capacitors having higher energy storage capabilities are considered supercapacitors (or ultracapacitors). These supercapacitors commonly include an electrode at least partially submerged in an electrolyte within a sealed, metallic housing. In that regard, undesirable chemical reactions have been known to occur between the housing and the electrolyte at higher voltages, and such chemical reactions can negatively affect the performance and useful life of the supercapacitor.

### BRIEF DESCRIPTION OF THE DRAWINGS

Non-limiting and non-exhaustive embodiments are described with reference to the following Figures, wherein like reference numerals refer to like parts throughout the various views unless otherwise specified.

FIG. 1 is a side view of a supercapacitor.

FIG. 2 is an exploded view of the supercapacitor shown in FIG. 1.

FIG. 3 is a cross-sectional view of the supercapacitor shown in FIG. 1 taken along plane 3-3 of FIG. 1.

FIG. 4 is an enlarged portion of the cross-section shown in FIG. 3 taken within region 4.

### DETAILED DESCRIPTION OF THE INVENTION

Electrochemical energy storage device constructions and methods of manufacture are set forth below. Such constructions and methods facilitate providing devices that overcome the disadvantages and problems discussed above. Notably, while the constructions and methods disclosed below are believed to be particularly beneficial for electrochemical capacitor devices (e.g., supercapacitor devices), the techniques described below may be extended to devices beyond those specifically described herein. Accordingly, the following description is intended for purposes of illustration rather than limitation. That is, the inventive concepts herein are not necessarily limited to the specific embodiments described below and represented in the Figures.

The term supercapacitor as used herein refers generally to a class of electrochemical capacitors having a specific capacitance of greater than 100 F/g, including electric double-layer capacitors, supercondensers, pseudocapacitors, electrochemical double-layer capacitors, and ultracapacitors. Such supercapacitors are useful in a variety of applications including, but not limited to, memory backup to bridge short power interruptions, battery management applications to improve the current handling of a battery or to provide a current boost on high load demands, fuel cell applications to enhance peak-load performance, regenerative braking on vehicles, and vehicle starting systems.

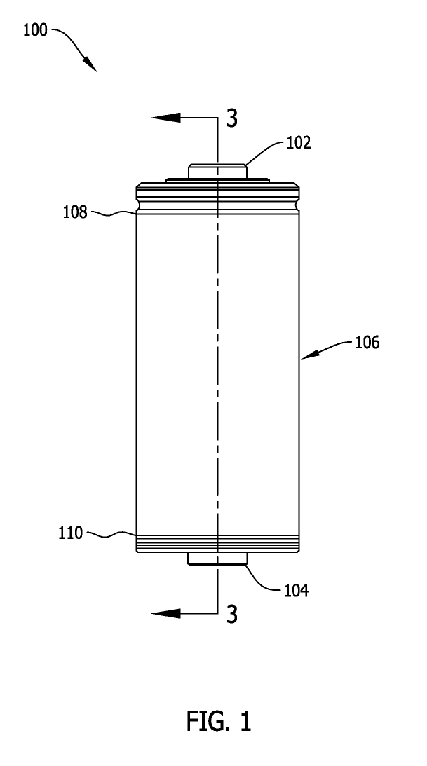

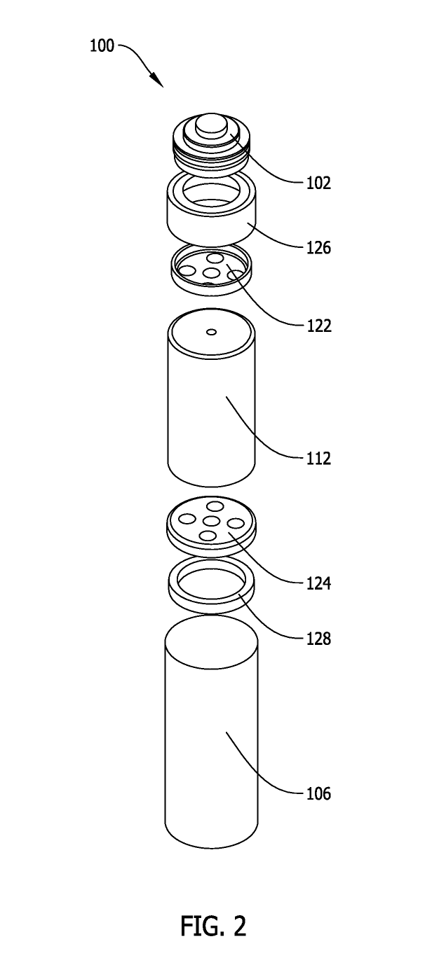

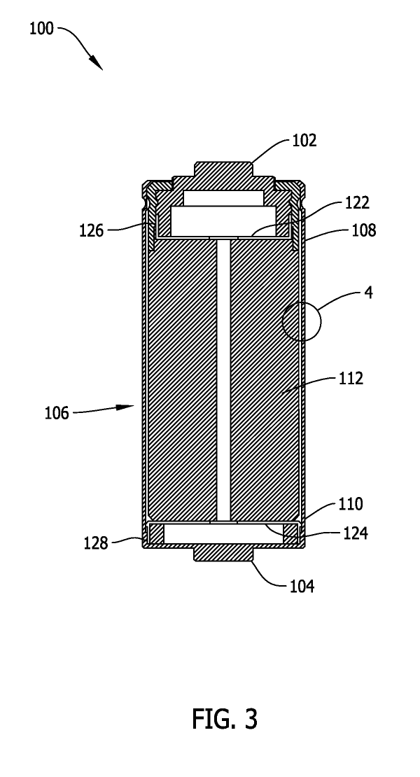

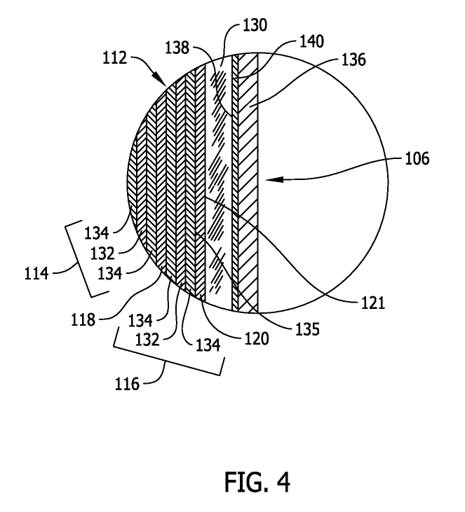

FIGS. 1-4 are various views of an electrochemical energy storage device 100 having a first (or negative) terminal 102, a second (or positive) terminal 104, and a tubular (e.g., generally cylindrical) housing 106 having a first end region 108 and a second end region 110. The electrochemical energy storage device 100 is a supercapacitor in the illustrated embodiment (e.g., a 2.7V supercapacitor). However, in other embodiments, the electrochemical energy storage device 100 may be of any suitable type that functions as described herein. While the first terminal 102 and the second terminal 104 are located at opposing end regions 108, 110 of the housing 106 in the illustrated embodiment (i.e., the housing 106 is configured to be electrically charged during operation of the device 100 in the illustrated embodiment), the first terminal 102 and the second terminal 104 may be located at the same end region 108, 110 of the housing 106 in some embodiments (e.g., the housing 106 may be configured to not be electrically charged during operation of the device 100 in some embodiments). Moreover, while the illustrated first terminal 102, second terminal 104, and housing 106 are all fabricated from a metallic material (e.g., aluminum), other embodiments may have the first terminal 102, the second terminal 104, and the housing 106 fabricated from any suitable material.

In the illustrated embodiment, a spiral-wound electrode arrangement 112 (commonly referred to as a “jellyroll”) is inserted into the housing 106. The arrangement 112 is a layered configuration of at least the following components: a first electrode 114, a second electrode 116, a first separator 118, and a second separator 120. The first separator 118 is disposed between the first electrode 114 and the second electrode 116, and the second separator 120 is adjacent the second electrode 116 such that the second separator 120 forms an outer surface 121 of the electrode arrangement 112 (i.e., when the electrode arrangement 112 is inserted into the housing 106, the second separator 120 is disposed between the second electrode 116 and the housing 106). In the illustrated embodiment, each of the first and second separators 118, 120 is fabricated from a sheet of porous (e.g., cellulose-based) material. In other embodiments, however, the separators 118, 120 may be fabricated from any suitable material. Moreover, the electrode arrangement 112 is retained in its spiral-wound configuration by a suitable tape (not shown) wrapped around the second separator 120. In alternative embodiments, the electrode arrangement 112 may have any suitable number of electrodes and separators fabricated in any suitable shapes from any suitable materials and arranged in any suitable manner that facilitates enabling the housing 106 to function as described herein.

In the illustrated embodiment, the electrochemical energy storage device 100 further includes a first cup 122 and a second cup 124 welded to opposite ends of the electrode arrangement 112, and each cup 122, 124 functions as a base for welding (i.e., electrically connecting) a respective one of the terminals 102, 104 to the electrodes 114, 116. More specifically, the first cup 122 is welded to the electrodes 114, 116, and the first terminal 102 is welded to the first cup 122. Similarly, the second cup 124 is welded to the electrodes 114, 116, and the second terminal 104 is welded to the second cup 124. Moreover, an insulative or non-conductive (e.g., rubber) O-ring 126 is provided for electrically isolating the first terminal 102 from the housing 106, and a support ring 128 is provided for supporting the second cup 124 at the second terminal 104. Furthermore, the housing 106 is at least partially filled with an electrolyte 130 (e.g., the electrolyte 130 may be injected into the housing 106 in a suitable manner) such that the electrolyte 130 permeates the separators 118, 120 and contacts the electrodes 114, 116. In this manner, ion mobility between the electrodes 114, 116 and the electrolyte 130 through the separators 118, 120 is facilitated.

In the illustrated embodiment, each of the first and second electrodes 114, 116 is fabricated from an aluminum foil sheet 132 having an activated carbon coating 134 that covers at least a segment of the sheet 132 (i.e., an outer surface 135 of the activated carbon coating 134 of the second electrode 116 faces a sidewall 136 of the housing 106 through the second separator 120). Notably, an interior surface 138 of the sidewall 136 of the housing 106 is also provided with an activated carbon coating 140. For example, in some embodiments, the interior surface 138 of the housing 106 may have the same composition of activated carbon coating 140 as the activated carbon coating 134 of the electrodes 114, 116 (e.g., in some embodiments, the activated carbon coating 134 of the electrodes 114, 116 and the activated carbon coating 140 of the housing 106 may utilize the same binder material). In one particular embodiment, the activated carbon coating 140 covers the entire interior surface 138 of the sidewall 136 of the housing 106, so as to extend from the first end region 108 of the housing 106 to the second end region 110 of the housing 106 about the entire circumference of the housing 106. As used herein, the term “activated carbon” refers to a carbon-based material that has been processed so as to be made more porous in order to increase the surface area of the carbon-based material and, therefore, enhance the electrical charge storage capability of the carbon-based material.

Of particular note is that, had the interior surface 138 of the housing 106 been left uncoated, the electrical charge stored in the outer surface 135 of the activated carbon coating 134 of the second electrode 116 during operation of the device 100 may have yielded an undesirable difference in voltage between the second electrode 116 and the housing 106 relative to a reference. Such an increase in the potential relative to a reference could have resulted in undesirable reactions between the electrolyte 130 and the uncoated interior surface 138 of the housing 106. These reactions could have produced a gaseous byproduct that could have built up within the housing 106, ultimately diminishing the overall performance and useful life of the device 100. However, by providing the interior surface 138 of the housing 106 with the activated carbon coating 140 in the illustrated embodiment, these undesirable reactions between the electrolyte 130 and the housing 106 are inhibited. Additionally, the activated carbon coating 140 of the housing 106 (much like the activated carbon coating 134 of the electrodes 114, 116) facilitates storing electrical charge during operation of the device 100, thereby increasing the overall capacitance of the device 100.

In other words, the activated carbon coating 140 on the interior surface 138 of the housing 106 facilitates providing a passivation layer between the electrolyte 130 and the sidewall 136 of the housing 106. In addition to this passivation benefit, the activated carbon coating 140 also stores electrical charge to enhance the overall capacitance of the device 100. Moreover, the activated carbon coating 140 also facilitates shifting the voltage at the housing 106 (i.e., because the activated carbon coating 140 stores electrical charge, the voltage imbalance between the housing 106 and the second electrode 116 can be shifted into a more desirable range). In that regard, the thickness of the activated carbon coating 140 can be selected to suit a desired, predetermined shift in voltage (e.g., the activated carbon coating 140 can be made thicker to yield a greater voltage shift, or can be made thinner to yield less of a voltage shift). Such a voltage shifting effect facilitates inhibiting reactions between the housing 106 and the electrolyte 130, thereby increasing the overall performance and useful life of the device 100.

The benefits of the present invention are now believed to have been amply illustrated in relation to the exemplary embodiments disclosed.

An embodiment of an electrochemical energy storage device has been disclosed. The device includes a housing, an electrolyte contained within the housing, and an electrode arrangement at least partially submerged in the electrolyte. The housing has an interior surface coated in an activated carbon material.

Optionally, the electrochemical energy storage device may be a supercapacitor. The electrochemical energy storage device may further be a 2.7V supercapacitor. Also, the housing may be a tubular housing. Furthermore, the electrode arrangement may be a spiral-wound electrode arrangement. The electrode arrangement may have a layered configuration of at least one electrode and at least one separator. Additionally, the separator may be disposed between the electrode and the housing. The layered configuration may have a pair of electrodes and a pair of separators. Further, the electrode may be fabricated from an aluminum foil sheet. Also, at least a segment of the aluminum foil sheet may be coated in an activated carbon material. The housing may have a first end region and a second end region, and the device may further include a first terminal located at the first end region and a second terminal located at the second end region. Furthermore, the housing may be configured to be electrically charged during operation of the device. Also, the housing may have a first end region and a second end region, and the device may further include a first terminal and a second terminal both located at the first end region of the housing. The housing may be configured to not be electrically charged during operation of the device. The electrode arrangement may include an electrode having an activated carbon coating, and the activated carbon coating of the electrode may have the same composition as the activated carbon coating of the housing.

Furthermore, the activated carbon coating of the electrode and the activated carbon coating of the housing may utilize the same binder material. Also, the housing may have a first end region and a second end region, and the activated carbon coating may extend from the first end region to the second end region of the housing. The housing may be tubular and may have a circumference, and the activated carbon coating may extend about the circumference of the housing. The activated carbon coating may provide a passivation layer on the interior surface of the housing. Additionally, the electrode arrangement may include an electrode and a separator disposed between the electrode and the interior surface of the housing, and the electrode may have an activated carbon coating with an outer surface that faces the interior surface of the housing through the separator. The activated carbon coating of the housing may also be configured to store electrical charge. Further, the activated carbon coating of the housing may be configured to shift the voltage at the housing. Also, the thickness of the activated carbon coating of the housing may be selected to yield a predetermined shift in voltage.

An embodiment of a method of fabricating an electrochemical energy storage device has also been disclosed. The method includes providing an electrode having an activated carbon coating, and the method also includes providing a housing having an interior surface coated with activated carbon. The method further includes inserting the electrode into the housing, and the method also includes injecting an electrolyte into the housing.

Optionally, the method may include rolling the electrode into a spiral-wound electrode arrangement. The method may further include disposing a separator adjacent the electrode such that the separator forms an outer surface of the electrode arrangement. The method may also include inserting the electrode arrangement into the housing such that an outer surface of the activated carbon coating of the electrode faces the activated carbon coating of the housing through the separator. Additionally, the method may include providing the electrode and the housing with the activated carbon coatings being made from the same activated carbon material composition. The activated carbon coatings may also utilize the same binder material. The method may also include providing the housing with the activated carbon coating of the housing extending from a first end region of the housing to a second end region of the housing. The method may further include providing the housing as a tubular housing having a circumference, wherein the activated carbon coating of the housing extends about the circumference of the housing.

An electrochemical energy storage device has also been disclosed. The device includes a generally cylindrical housing fabricated from aluminum, and the housing has a first end region, a second end region, and an interior surface. The device also includes an electrolyte contained within the housing, as well as a spiral-wound electrode arrangement at least partially submerged in the electrolyte. The electrode arrangement includes: a first electrode fabricated from a first aluminum foil sheet coated in activated carbon; a second electrode fabricated from a second aluminum foil sheet coated in activated carbon; a first cellulose-based separator disposed between the first electrode and the second electrode; and a second cellulose-based separator disposed between the second electrode and the interior surface of the housing. The interior surface of the housing has an activated carbon coating that faces the activated carbon coating of the second electrode.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electrochemical energy storage device comprising:
a housing;
an electrolyte contained within the housing; and
an electrode arrangement at least partially submerged in the electrolyte,
wherein the housing comprises an interior surface coated with an activated carbon material.

2. The electrochemical energy storage device of claim 1, wherein the electrode arrangement includes an aluminum foil sheet.

3. The electrochemical energy storage device of claim 2, wherein at least a segment of the aluminum foil sheet is coated in an activated carbon material.

4. The electrochemical energy storage device of claim 1, wherein the housing comprises a first end region and a second end region, the device further comprising a first terminal located at the first end region and a second terminal located at the second end region.

5. The electrochemical energy storage device of claim 4, wherein the housing is configured to be electrically charged during operation of the device.

6. The electrochemical energy storage device of claim 1, wherein the housing comprises a first end region and a second end region, the device further comprising a first terminal and a second terminal both located at the first end region of the housing.

7. The electrochemical energy storage device of claim 6, wherein the housing is configured to not be electrically charged during operation of the device.

8. The electrochemical energy storage device of claim 1, wherein the electrode arrangement comprises an electrode having an activated carbon coating, the activated carbon coating of the electrode having the same composition as the activated carbon coating of the housing.

9. The electrochemical energy storage device of claim 8, wherein the activated carbon coating of the electrode and the activated carbon coating of the housing utilize the same binder material.

10. The electrochemical energy storage device of claim 1, wherein the housing comprises a first end region and a second end region, the activated carbon coating extending from the first end region to the second end region of the housing.

11. The electrochemical energy storage device of claim 10, wherein the housing is tubular and has a circumference, the activated carbon coating extending about the circumference of the housing.

12. The electrochemical energy storage device of claim 1, wherein the activated carbon coating provides a passivation layer on the interior surface of the housing.

13. The electrochemical energy storage device of claim 12, wherein the electrode arrangement comprises an electrode and a separator disposed between the electrode and the interior surface of the housing, the electrode comprising an activated carbon coating having an outer surface that faces the interior surface of the housing through the separator.

14. The electrochemical energy storage device of claim 13, wherein the activated carbon coating of the housing is configured to store electrical charge.

15. The electrochemical energy storage device of claim 14, wherein the activated carbon coating of the housing is configured to shift the voltage at the housing.

16. The electrochemical energy storage device of claim 1, wherein the electrochemical energy storage device is a supercapacitor.

17. A method of fabricating an electrochemical energy storage device, the method comprising:
providing an electrode having an activated carbon coating;
providing a housing having an interior surface coated with activated carbon;
inserting the electrode into the housing; and
injecting an electrolyte into the housing.

18. The method of claim 17, further comprising:
rolling the electrode into a spiral-wound electrode arrangement;
disposing a separator adjacent the electrode such that the separator forms an outer surface of the electrode arrangement; and
inserting the electrode arrangement into the housing such that an outer surface of the activated carbon coating of the electrode faces the activated carbon coating of the housing through the separator.

19. The method of claim 17, further comprising providing the electrode and the housing with the activated carbon coatings being made from the same activated carbon material composition and utilizing the same binder material.

20. An electrochemical energy storage device comprising:
a generally cylindrical housing fabricated from aluminum, the housing having a first end region, a second end region, and an interior surface;
an electrolyte contained within the housing; and
a spiral-wound electrode arrangement at least partially submerged in the electrolyte, the electrode arrangement comprising:
a first electrode fabricated from a first aluminum foil sheet coated in activated carbon;
a second electrode fabricated from a second aluminum foil sheet coated in activated carbon;
a first cellulose-based separator disposed between the first electrode and the second electrode; and
a second cellulose-based separator disposed between the second electrode and the interior surface of the housing,
wherein the interior surface of the housing has an activated carbon coating that faces the activated carbon coating of the second electrode.
